(19) United States
(12) Patent Application Publication
(10) Pub. No.: US 2005/0117013 A1
(43) Pub. Date: Jun. 2, 2005

(54) Method and device for correcting white streak and thermal printer

(75) Inventor: Junji Hayashi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 10/995,488

(22) Filed: Nov. 24, 2004

(30) Foreign Application Priority Data
Nov. 27, 2003 (JP) 2003-397961

(51) Int. Cl. B41J 2/325

(52) U.S. Cl. 347/179

(57) ABSTRACT

In a thermal printer, resistance values of individual heating elements of a thermal head are measured to check if there is any heating element that breaks down. If a broken heating element RN is determined, heat energy values YEn, YEn−1, YEn+1, YEn−2 and YEn+2 necessary for pixels to be printed by the broken heating element RN and neighboring heating elements RN−1, RN+1, RN−2 and RN+2 are calculated. The heat energy values YEn−1, YEn+1, YEn−2 and YEn+2 are corrected by adding predetermined percentages of the heat energy value YEn of the broken heating element RN to these values. Based on the corrected heat energy values YEn−1, YEn+1, YEn−2 and YEn+2, image data for the neighboring heating elements RN−1, RN+1, RN−2 and RN+2 are corrected. The heat energy generated from the neighboring heating elements increase so much as to print also the pixels assigned to the broken heating element, preventing white streaks.

### FIELD OF THE INVENTION

The present invention relates to a thermal printer having a thermal head on which a number of heating elements arranged in a line along a main scan direction, wherein said heating elements apply heat energies for printing an image line by line on a recording material as the recording material is moved relative to the thermal head in a sub scan direction perpendicular to the main scan direction. More particularly, the present invention relates to a method of and an apparatus for correcting white streaks in the printed image, which are caused by breakdown of any of the heating elements, and a thermal printer adopting such a correction method or device.

### BACKGROUND ARTS

Thermal printers have been widely used, wherein an image is printed on a recording paper by use of a thermal head having a large number of heating elements. The thermal printers include heat sensitive type and thermal transfer type. The heat sensitive type printer heats heat-sensitive recording paper directly by the heating elements of the thermal head, to develop colors. On the other hand, in the thermal transfer type printer, an ink ribbon is laid on recording paper and is heated from opposite side to the recording paper, to transfer ink from the ink ribbon to the recording paper. The thermal transfer type printers include sublimation type thermal printers that print dots at variable densities on the recording paper by controlling volume of heat energies generated from the heating elements.

The heating elements of the thermal head are constituted of heat-generating resistive elements whose heat release value varies depending upon current and voltage applied thereto. The heat-generating resistive elements have resistance variations, which are about 5% to 10% even before they are used, and also change with age and printing conditions. With a change in resistance of the heating element, the heat energy or heat value generated from the heating element will change. If the resistance variations between the heating elements are so large, the printed image will suffer density unevenness or other defects. In order to prevent the density unevenness caused by the resistance variations of the heating elements, such thermal printers have been known that measure resistance values of the heating elements to correct image data for the heating elements on the basis of the measured resistance values, for example, from Japanese Laid-open Patent Application Nos. Hei 06-079897, Hei 09-193437 and 2001-162850.

It is also known in the art that the heating element can break down when its resistance value gets too large as a result of wearing. Because the broken heating element will not heat even while an electric power is supplied to it, the subsequent image will contain streaks. The streak is a stripe of blank portion inside the image, as the broken heating element cannot print any dot. So the streaks caused by the broken heating elements are called white streaks because they show the base color of the recording paper. The white streaks damage the image quality so badly.

The white streaks cannot be corrected by the density correction method disclosed in the above mentioned prior arts. The only way to solve this problem has conventionally been replacing the thermal head. Meanwhile, with the development in miniaturization technique, the heating elements of the thermal head have been miniaturized in size, pitch, and wire-boldness and so on. The miniaturized heating element can be more likely to break down.

### SUMMARY OF THE INVENTION

In view of the foregoing, a primary object of the present invention is to provide a white streak correction method for preventing white streaks from being caused by breakdown of any of a number of heating elements which are arranged in a line on a thermal head, and are heated in accordance with drive data generated from image data, to apply heat energies for printing a grayscale image line by line on a recording material.

Another object of the present invention is to provide a correction device that makes the white streaks less prominent or unnoticeable.

A further object of the present invention is to provide a thermal printer adopting such a white streak correction method or device.

To achieve the above and other objects, the inventive white streak correction method comprises steps of determining a broken heating element among the heating elements; and correcting image data or drive data for neighboring ones of the heating elements, which are placed in the neighbor of the broken heating element, such that a percentage of heat energy to be applied from the broken heating element is added to heat energies applied from the neighboring heating elements.

According to a preferred embodiment, the broken heating element is determined by measuring respective resistance values of the heating elements.

The neighboring heating elements include at least heating elements bordering on the broken heating element and heating elements adjacent to the bordering heating elements on opposite sides from the broken heating element. It is preferable to correct the image data or the drive data for the neighboring heating elements such that the percentage of added heat energy decreases with the distance from the broken heating element.

According to the present invention, a thermal printer comprises a thermal head having a number of heating elements arranged in a line along a main scan direction, wherein the heating elements are heated in accordance with drive data generated from image data, to apply heat energies from the heating elements for printing an image line by line on a recording material as the recording material is moved relative to the thermal head in a sub scan direction perpendicular to the main scan direction; a determination device for determining a broken heating element among the heating elements; and a data correction device for correcting image data or drive data for neighboring ones of the heating elements, which are placed in the neighbor of the broken heating element, such that a percentage of heat energy to be applied from the broken heating element is added to heat energies applied from the neighboring heating elements.

Where the thermal printer is a color thermal printer that produces a color image by printing images of different colors on the recording material, the data correction device preferably corrects the image data or the drive data for the neighboring heating elements by use of correction coefficients determined by the color to print.

According to a preferred embodiment, each of the heating elements is inclined to the sub scan direction.

It is also preferable to provide the thermal printer with a warning device for warning about the breakdown when successive two or more of the heating elements break down.

According to the correction method and correction device of the present invention, those heating elements bordering the broken heating element and those in the vicinity of the broken heating element are used for printing such pixels that cannot be printed by the broken heating element and that would otherwise appear as the white streak. Therefore, the white streak will become less prominent or unnoticeable.

The broken heating element can be determined without failure by measuring the resistance values of the respective heating elements. Because a resistance measuring device consists of a small number of components, and does not need a large mounting space, it is possible to incorporate the resistance measuring device into a thermal printer at a low cost without the need for enlarging the printer size.

Reducing the additional ratio of heat energy with distance from the broken heating element will prevent enhancing the density of the bordering pixels alone conspicuously.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic diagram illustrating a color thermal printer according to an embodiment of the invention;

FIG. 2 is a fragmentary sectional view illustrating a layered structure of color heat-sensitive recording paper;

FIGS. 3A, 3B, 3C and 3D are explanatory diagrams illustrating a method of correcting heat energy applied from heating elements neighboring on a broken heating element;

FIG. 4 is a block diagram illustrating an internal structure of the color thermal printer according to the embodiment of the present invention;

FIG. 5 is a block diagram illustrating in more detail a thermal head, a head driver, a system controller and resistance measuring circuit of FIG. 4;

FIG. 6 is a flowchart illustrating a method of correcting image data applied to the neighboring heating elements;

FIGS. 7A and 7B are explanatory diagrams illustrating a method of correcting heat energy applied from heating elements neighboring on a broken heating element according to another embodiment;

FIG. 8 is an explanatory diagram illustrating a thermal head according to another embodiment; and

FIG. 9 is an explanatory diagram illustrating a thermal head according to still another embodiment.

### DETAILED DESCRIPTION OF THE PREFERRED EMBODIMENTS

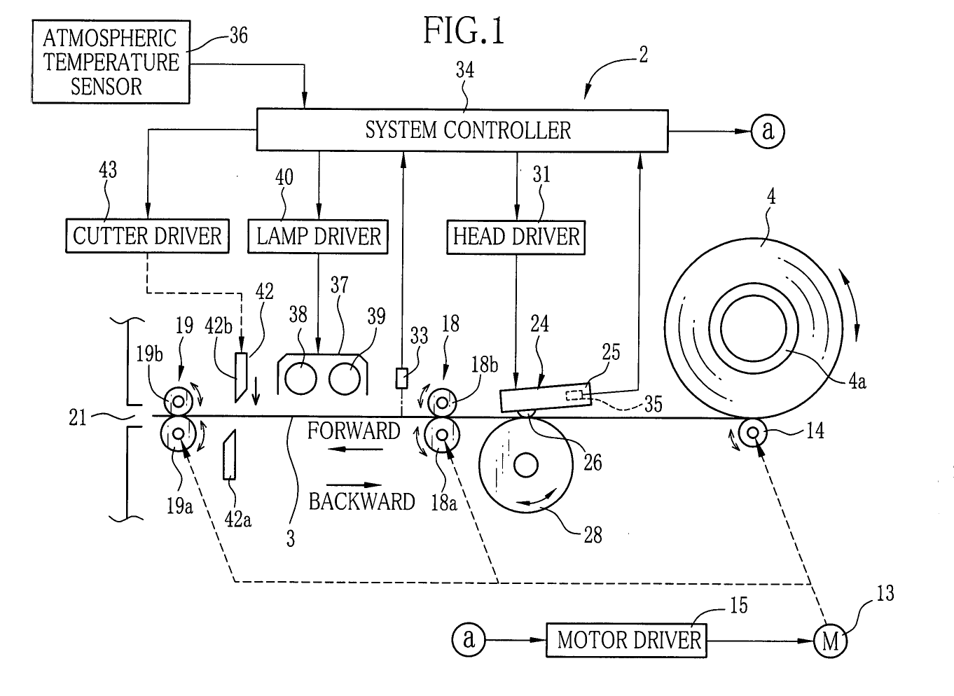

FIG. 1 shows a color thermal printer embodying the present invention. The color thermal printer 2 uses a long web of color heat-sensitive recording paper 3 as a recording material. The color heat sensitive recording paper 3 is sold as a recording paper roll 4 in the market, and the recording paper roll 4 is set in the color thermal printer 2.

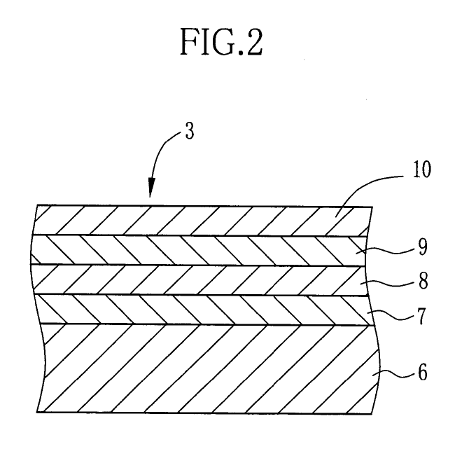

As shown in FIG. 2, the color heat sensitive recording paper 3 has three thermosensitive coloring layers for cyan, magenta and yellow 7, 8 and 9, which are formed atop another on a base sheet 6 in this order from the base sheet 6 toward a top protection layer 10. The topmost yellow coloring layer 9 has the highest heat sensitivity, so it develops yellow upon the smallest amount of heat energy among these coloring layers 7 to 9. The bottommost cyan coloring layer 7 has the lowest heat sensitivity, so it develops cyan with the largest amount of heat energy among these coloring layers 7 to 9.

The yellow coloring layer 9 loses its coloring ability when exposed to near ultraviolet rays of 420 nm. The magenta coloring layer 8 colors magenta when it takes heat energy of an intermediate amount that is between the heat energy for the yellow coloring layer 9 and the heat energy for the cyan coloring layer 7. The magenta coloring layer 8 loses its coloring ability when exposed to ultraviolet rays of 365 nm.

It is to be noted that there is color heat-sensitive recording paper having four thermosensitive coloring layers, for example, a black coloring layer in addition to the cyan, magenta and yellow coloring layers. The present invention is applicable to those cases where the heat-sensitive recording paper has four thermosensitive coloring layers.

A feed roller 14 is pressed on an outer periphery of the recording paper roll 4 in the roll chamber 5. The feed roller 14 is turned by a feed motor 13. The feed motor 13 is a pulse motor that is driven by pulses generated from a motor driver 15. As the feed roller 14 turns in a counterclockwise direction in the drawings, the recording paper roll 4 is turned in a clockwise direction in the drawings, so the color heat sensitive recording paper 3 is fed out from the recording paper roll 4. On the contrary, as the feed roller 14 turns in the clockwise direction, the recording paper roll 4 is turned in the counterclockwise direction, winding back the color heat sensitive recording paper 3.

After being fed out from the recording paper roll 4, the color heat sensitive recording paper 3 is fed into a paper passageway that extends in a horizontal direction. A feed roller pair 18 and an ejection roller pair 19 are disposed in the paper passageway, for conveying the color heat sensitive recording paper 3 while nipping it. The feed roller pair 18 and the ejection roller pair 19 consist of a capstan roller 18a or 19a and a pinch roller 18b or 19b. The capstan rollers 18a and 19a are turned by the feed motor 13, whereas the pinch rollers 18b and 19b are pressed against the capstan rollers 18a and 19a respectively. The color heat sensitive recording paper 3 is pinched between the pinch roller 18b or 19b and the capstan roller 18a or 19a, to be fed in a forward or feed out direction and a backward or wind-back direction, by turning the capstan roller 18a or 19a forwardly and reversely. A paper exit 21 is disposed at a position behind the ejection roller pair 33 in the forward direction, for ejecting the color heat sensitive recording paper 3 from the color thermal printer 2, after the color heat sensitive recording paper 3 has a full-color image printed thereon.

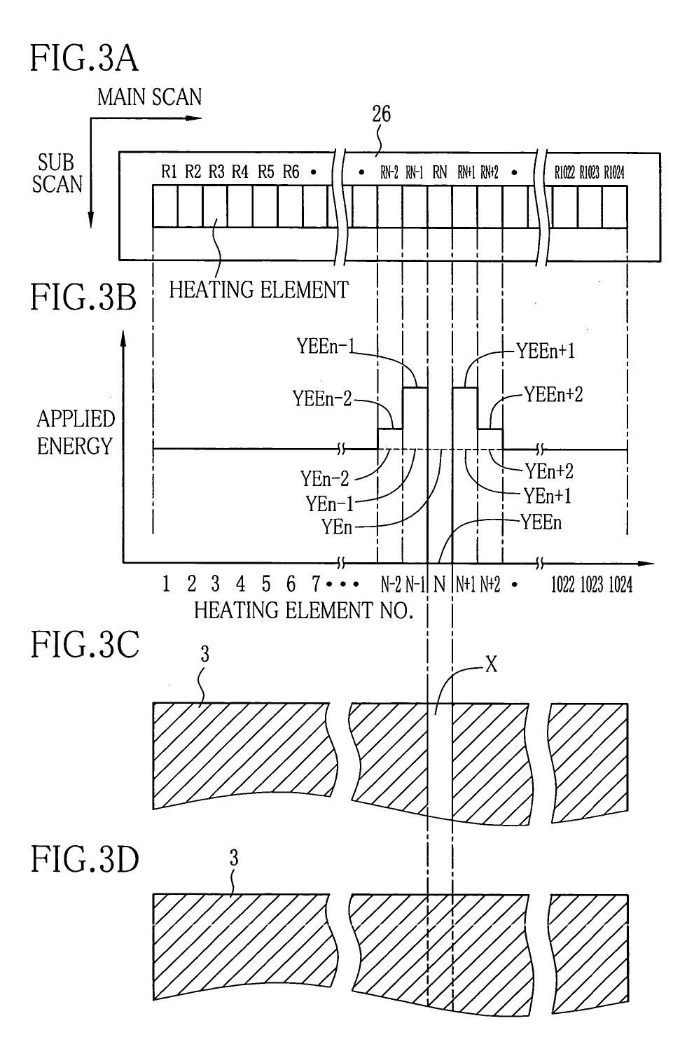

A thermal head 24 is disposed between the recording paper roll 4 and the feed roller pair 18, and above the paper passageway. A platen roller 28 is disposed across the paper passageway from the thermal head 24. The thermal head 24 is constituted of a head base 25 made of ceramics, alumina, alumina-ceramics or the like, a printing ridge 26 provided on a bottom of the head base 25, and a large number of heating elements R1 to R1024, which are arranged side by side on the printing ridge 26, as shown in FIG. 3A. Each of the heating elements R1 to R1024 can print a pixel at a time. The printing ridge 26 extends in a perpendicular direction to the paper conveying directions, and the heating elements R1 to R1024 are aligned in this direction, so an image is recorded line by line on the recording paper 3, as the recording paper 3 moves past the thermal head 24. Therefore, the perpendicular direction is called a main scan direction, whereas the paper conveying direction is called a sub scan direction.

The platen roller 28 is movable up and down, and is urged in a direction to be pressed against the printing ridge 26 of the thermal head 24 by a not-shown spring. By a not-shown shift mechanism that is constituted of cams and solenoids, the platen roller 28 is moved down to be apart from the thermal head 24, while the color heat sensitive recording paper 3 is being initially fed out of the recording paper roll 4, as well as while the color heat sensitive recording paper 3 is being ejected through the exit 21.

While the color heat sensitive recording paper 3 is being fed in the forward direction by the feed roller pair 18, the color heat sensitive recording paper 3 is pinched between the printing ridge 26 and the platen roller 28. The heating elements R1 to R1024 are heated in accordance with drive data that are supplied to a head driver 31, to make the coloring layers 7 to 9 develop their colors. The platen roller 28 rotates along with the feeding movement of the color heat sensitive recording paper 3, so as to keep the color heat sensitive recording paper 3 in stable contact with the heating elements.

An optical sensor 33 is mounted in a position behind the feed roller pair 18 in the forward direction, so as to detect a leading edge of the color heat sensitive recording paper 3. A detection signal from the optical sensor 33 is sent to the system controller 34, and is used for controlling the color thermal printer 2. A head temperature sensor 35 is attached to the thermal head 24. The head temperature sensor 35 measures the temperature of the head base 25, and sends the measured value to the system controller 34. An atmospheric temperature sensor 36 is also provided for measuring the temperature inside housing of the color thermal printer 2. The measured value is also sent to the system controller 34. The measured values from these temperature sensors 35 and 36 are used for density control during the printing.

An optical fixing device 37 is disposed behind the optical sensor 33 in the forward direction, in face to a recording surface of the color heat sensitive recording paper 3, the recording surface being brought into contact with the printing ridge 26. The optical fixing device 37 consists of a yellow fixing lamp 38 and a magenta fixing lamp 39. The yellowing fixing lamp 38 emits near-ultraviolet rays having an emission peak at 420 nm, for fixing the yellow coloring layer 9. The magenta fixing lamp 39 emits ultraviolet rays having an emission peak at 365 nm, for fixing the magenta coloring layer 8. These lamps 48 and 49 are driven to emit light by a lamp driver 40.

A cutter 42 is disposed between the optical fixing device 37 and the ejection roller pair 19, for cutting the color heat sensitive recording paper 3 along the widthwise direction thereof. The cutter 42 has a stationary blade 42a that is fixedly mounted below the paper passageway, and a movable blade 42b that is movable up and down by a cutter drive mechanism 43. The color heat sensitive recording paper 3 is cut by being nipped between these blades 42a and 42b.

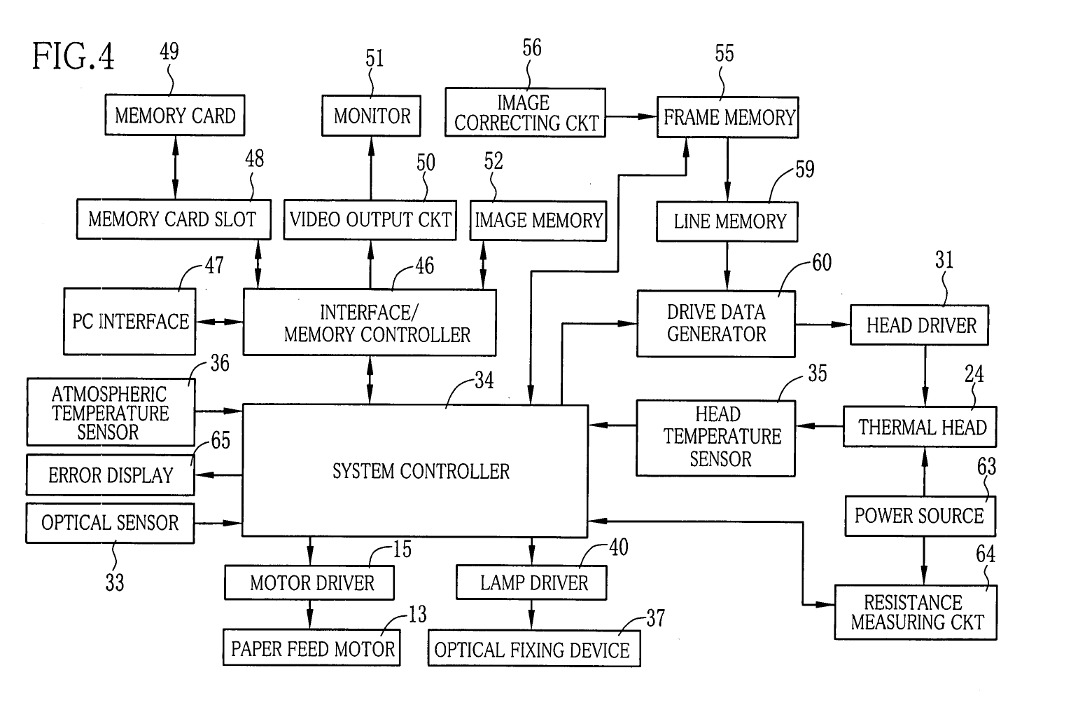

FIG. 4 shows the internal structure of the color thermal printer 2. The system controller 34 consists of a microcomputer that is mainly provided with a ROM storing control programs for the color thermal printer 2, a RAM for storing temporarily various data generated during the control, and a CPU for controlling respective parts on the basis of the control programs. Besides the motor driver 15, the head driver 31 and the lamp driver 40, many kinds of circuits and devices are connected to the system controller 34.

An interface/memory controller 46 controls data communication of the color thermal printer 2 with external devices, like a personal computer and a memory card 49, through interfaces, including a PC interface 47 and a memory card slot 48. The memory card slot 48 is for accepting the memory card 49 on which image data are written by a digital camera or the like. The interface/memory controller 46 reads out the image data from the memory card 49, to display images on a monitor 51 through a video output circuit 50. Among the image data read out from the memory card 49, the interface/memory controller 46 writes in an image memory 52 image data of those images which are designated to be printed.

The system controller 34 reads out the image data from the image memory 52, and converts them into three color image data, i.e. yellow image data, magenta image data and cyan image data. The three color image data are stored in respective locations of a frame memory 55. An image correction circuit 56 corrects the yellow, magenta and cyan image data in accordance with correction values determined based on resistance values of the heating elements R1 to R1024, the temperature 24 of the thermal head 24, the temperature inside the housing of the thermal printer 2 and other factors.

The image data of each color are read out from the frame memory 55 line by line, and the image data of one line is stored in a line memory 59. A drive data generator 60 reads out the image data of one line from the line memory 59, and converts them into drive data for driving the heating elements R1 to R1024 of the thermal head 24. The head driver 31 drives the heating elements R1 to R1024 to heat in accordance with the drive data applied from the drive data generator 60, so that an image is printed on the color heat sensitive recording paper 3. The color thermal printer 2 is also provided with a power source section 63 for supplying power to the color thermal printer 2, a resistance measuring circuit 64 for measuring individual resistance values r1 to r1024 of the heating elements R1 to 1024, and an error display 65 for warning when breakdown is detected in successive two or more of the heating elements.

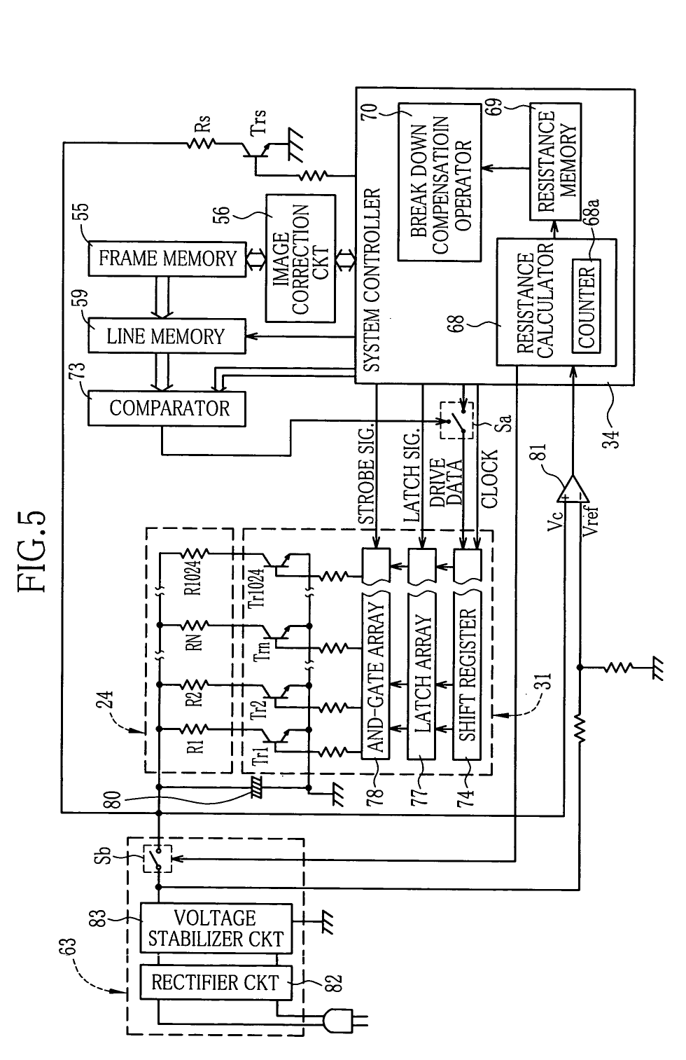

FIG. 5 shows the thermal head 24, the head driver 31, the system controller 34, the drive data generator 60, the power source section 63 and the resistance measuring circuit 64. The system controller 34 is provided with a resistance calculator 68 for calculating respective resistance values of the heating elements R1 to R1024 of the thermal head 24. The system controller 34 is also provided with a resistance memory 69 storing the calculated resistance values, and a breakdown compensation operator 70 for correcting image data if any of the heating elements breaks down. The drive data generator 60 consists of a comparator 73.

The comparator 73 compares image data of one line, which are read out from the line memory 59, with gradation data from the system controller 34. The comparator 73 outputs a binary value “1” or “0” when the image data of one pixel is higher or lower than a gradation level of the gradation data, respectively. The binary value is used as a drive signal. The drive signals are serially sent to a shift register 74, that is, as a series of serial drive data corresponding to the image data of one line. The comparator 73 is connected to the shift register 74 through a switch Sa that is used for switching over between a printing mode and a resistance measuring mode.

If, for example, the color thermal printer 2 is designed to reproduce 256 gradations, the gradation data of levels “0” to “255” are sequentially input in the comparator 73, to be compared with the image data of each pixel. Namely, the image data of each pixel is compared with the gradation data in 256 steps, so the subsequent drive signals are sent to the shift register 74 in 256 steps for each line. The shift register 74 is connected to a latch array 77, and the latch array 77 is connected to an AND-gate array 78. The latch array 77 consists of latch circuits of a number corresponding to the pixel number of one line, i.e. 1024 in this embodiment. Also, the AND-gate array 78 consists of the corresponding number of AND gates. The AND-gates of the AND-gate array 78 are connected through transistors Tr1 to Tr1024 to the heating elements R1 to R1024 of the thermal head 24 respectively. The heating elements are heat-generating resistive elements that heat up while being supplied with an electric power. The transistors Tr1 to Tr1024 are respectively connected at their collectors to the heating elements R1 to R1024, and at their bases to the AND-gates of the AND-gate array 78.

The shift register 74 shifts the serial drive data in synchronism with clock signals from the system controller 34, to convert the drive data into a parallel form. The parallel drive data from the shift register 74 are latched in the latch array 77 in synchronism with latch signals from the system controller 34. The AND-gate of the AND-gate array 78 outputs a high level signal “H” upon receipt of a strobe signal, so long as the drive data being input in that AND-gate is “n”. The transistors Tr1 to Tr1024 are turned on while the corresponding AND-gates of the AND-gate array 78 output the high level signal. Then the electric power is conducted through the corresponding heating elements R1 to R1024, causing them to release heat energy.

The resistance measuring circuit 64 consists of a reference resistor Rs, a reference transistor Trs, a capacitor 80, the switch Sa, a switch Sb and a comparator 81. The reference resistor Rs and the reference transistor Trs are connected in parallel to the heating elements R1 to R1024 and the transistors Tr1 to Tr1024. The reference resistor Rs is a resistor having a known resistance value rs with an error of about 1% or less. The switch Sb is disposed in the power source section 63 that consists of a rectifier circuit 82 and a voltage stabilizer circuit 83. The switch Sb is closed continually during the printing mode. During the resistance measuring mode, the switch Sb is controlled ON and OFF by the system controller 34, for measuring the resistance values r1 to r1024 of the heating elements R1 to R1024 one by one. The comparator 81 is connected at its non-inverted input to one end of the capacitor 80, and at its inverted input to the power source section 63.

The resistance measuring circuit 64 and the resistance calculator 68 detect the resistance values of the heating elements R1 to R1024 in the following manner:

First the switch Sa is switched over to connect the shift register 74 to the system controller 34 to set the color thermal printer 2 in the resistance measuring mode, for example, at the activation of the color thermal printer 2. The system controller 34 turns only the reference transistor Trs on, while leaving the transistors Tr1 to T1024 off, and turns the switch Sb on to start charging the capacitor 80.

When the charged voltage reaches a voltage Vc for starting discharging the capacitor 80, the system controller 34 turns the switch Sb off and, at the same time, lets a counter 68a of the resistance calculator 68 start counting time taken for the voltage at the non-inverted input of the comparator 81 to go down from the value Vc to a reference value Vref that is equal to a voltage applied to the inverted input. Multiplying the count of the counter 68a by a unit time “t” comes up to be a discharge time Ts through the reference resistor Rs.

Next, the transistor Tr1 alone is turned on, and the switch Sb is turned on again to charge the capacitor 80. When the capacitor 80 is charged up to the voltage Vc, the switch Sb is turned off, and the counter 68a starts counting time of discharging the capacitor 80 to the voltage Vref. Then, a discharge time “T1” of the capacitor 80 through the heating element R1 is obtained by multiplying the count by the unit time “t”. A resistance value “r1” of the heating element R1 is obtained by substitution of the known resistance value “rs” and the obtained discharge time “Ts” of the reference resistor Rs, and the obtained discharge time “T1” of the heating element R1 in the following equation:
r1=rs*T1/Ts

In the same way as above, resistance values r2 to r1024 of the heating elements R2 to R1024 can be calculated by use of the resistance value rs and the discharge time Ts of the reference resistor Rs, and discharge times measured with respect to the individual heating elements R2 to R1024. The above described method of measuring the resistance values of the heating elements is disclosed in more detail in the aforementioned prior art.

It is known that the heating elements have resistance variations of about 5% to 10% even at the manufacture, and the resistance values change with age and printing conditions. It is also known that the heating element can break down as a result of wearing. Referring to FIGS. 3A to 3D, when for example a heating element RN breaks down among the heating elements R1 to R1024, and if no compensation for this is made, then no dot is printed along a zone of the color heat sensitive recording paper 3, on which pixels are to be printed by the broken heating element RN, as shown in FIG. 3C, so that the blank zone of the recording paper 3 appears as a white streak X in the printed image. The white streak X remarkably damages the printed image.

To prevent such white streaks, the present invention suggests correcting image data of those pixels which are to be printed by the broken heating element RN, bordering heating elements RN−1 and RN+1 that border on the broken heating element RN, and adjacent heating elements RN−2 and RN+2 that are adjacent to the bordering heating elements RN−1 and RN+1. Concretely, as shown in FIG. 3B, the image data of the bordering heating elements RN−1 and RN+1 and the adjacent heating elements RN−2 and RN+2 are corrected to enhance heat energies from these heating elements over their requisite values determined by the original image data. Thereby, the zone to be printed by the broken heating element RN is colored by the enhanced heat energies from these heating elements RN−1, RN+1, RN−2 and RN+2, so that the white streak X fades out, as shown in FIG. 3D. It is to be noted that the bordering heating elements RN−1 and RN+1 and the adjacent heating elements RN−2 and RN+2 will be called the neighboring heating elements as a generic term.

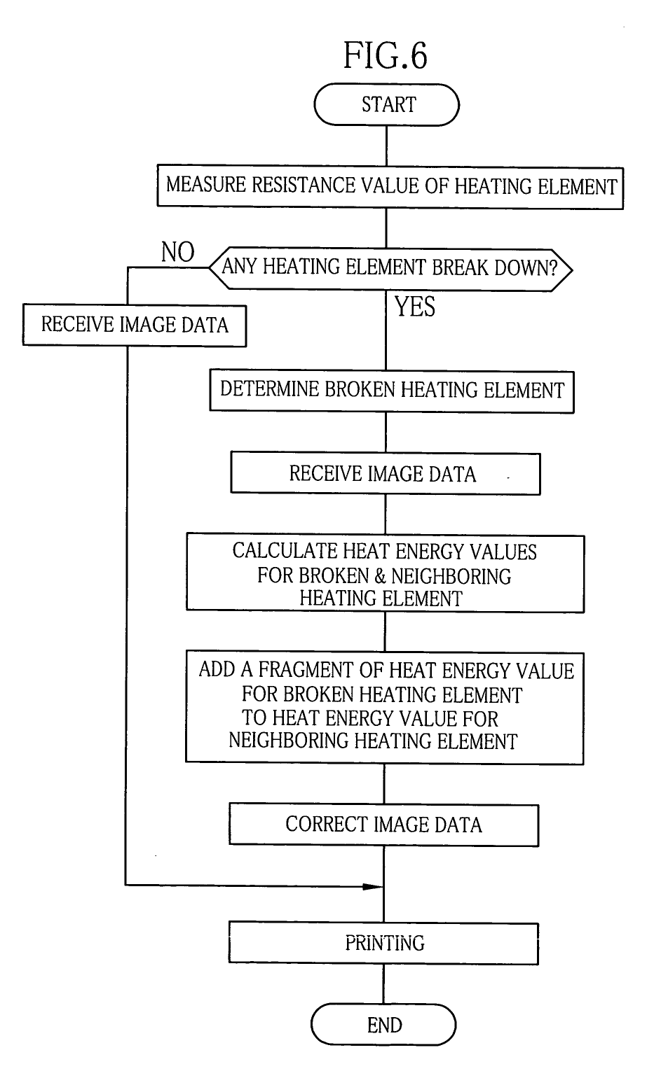

The compensation process for the breakdown of a heating element is executed for example in the sequence shown in the flowchart of FIG. 6. The broken heating element is detected by measuring the resistance values of the heating elements R1 to R1024 through the resistance measuring circuit 64 and the resistance calculator 68. Because the heating element has a very high resistance value in the breakdown condition, the broken heating element can be detected without fail. If the broken heating element RN is detected, the breakdown compensation operator 70 of the system controller 34 calculates heat energy values YEn, YEn−1, YEn+1, YEn−2 and YEn+2 necessary for printing yellow pixels by the broken heating element RN, the bordering heating elements RN−1 and RN+1, and the adjacent heating elements RN−2 and RN+2 respectively in accordance with the image data of these pixels.

Next, the breakdown compensation operator 70 calculates corrected heat energy values YEEn−1, YEEn+1, YEEn−2 and YEEn+2 for the neighboring heating elements RN−1, RN+1, RN−2 and RN+2 respectively. The corrected heat energy values YEEn−1 and YEEn+1 are obtained respectively by adding the heating energy values YEn−1 and YEn+1 and a heat energy value that is obtained by multiplying the heat energy value YEn of the broken heating element RN by a predetermined coefficient a1. The corrected heat energy values YEEn−2 and YEEn+2 are obtained respectively by adding the heating energy values YEn−2 and YEn+2 and a heat energy value that is obtained by multiplying the heat energy value YEn of the broken heating element RN by a coefficient a2 that is smaller than the coefficient a1. Namely, the corrected heat energy values YEEn−1, YEEn+1, YEEn−2 and YEEn+2 are obtained according to the following equations:
YEEn−1=YEn−1+YEn* a1
YEEn+1=YEn+1+YEn*a1
YEEn−2=YEn−2+YEn*a2
YEEn+2=YEn+2+YEn*a2

As shown in FIG. 3B, the corrected heat energy values YEEn−1, YEEn+1, YEEn−2 and YEEn+2 are higher than the respective standard heat energy values YEn−1, YEn+1, YEn−2 and YEn+2. Moreover, the corrected heat energy values YEEn−1 and YEEn+1 are higher than the corrected heat energy values YEEn−2 and YEEn+2. Because the broken heating element RN will not heat even while the electric power is supplied, the energy value YEn for the broken heating element RN is corrected to be zero: YEEn=0.

Based on the corrected heat energy values YEEn, YEEn−1, YEEn+1, YEEn−2 and YEEn+2, the image data for the yellow pixels are corrected.

Thereby, the pixels to be printed by the broken heating element RN are printed as shown in FIG. 3D, preventing the white streak X. Although the coloring density of the bordering heating elements RN−1 and RN+1 is enhanced by this correction, the enhancement will not be conspicuous because the coloring density of the adjacent heating elements RN−2 and RN+2 is also enhanced by a smaller degree than that of the bordering heating elements RN−1 and RN+1 such that the coloring density decreases to the uncorrected values with the distance from those pixels to be recorded by the broken heating element RN.

The gradation level can vary from pixel to pixel even among those recorded by the same heating element, that is, the pixels of different main scan lines but located at the same position in the main scan direction. Accordingly, the data correction for compensating for the breakdown is carried out line by line. If more than one of the heating elements R1 to R1024 are broken down, the above described correction is carried out on the image data for the neighboring heating elements to the respective broken heating elements.

The data correction for the broken and neighboring heating elements RN, RN−1, RN+1, RN−2 and RN+2 is carried out not only on the image data for yellow, but also on the image data for magenta and that for cyan. Because the data correction for magenta and cyan is carried out in the same way as for yellow, the detailed description of the correction sequence for magenta and cyan is omitted. However, since the magenta coloring layer 8 and the cyan coloring layer 7 are less heat-sensitive than the yellow coloring layer 9, it is preferable to preset higher correction coefficients a for magenta and cyan than for yellow.

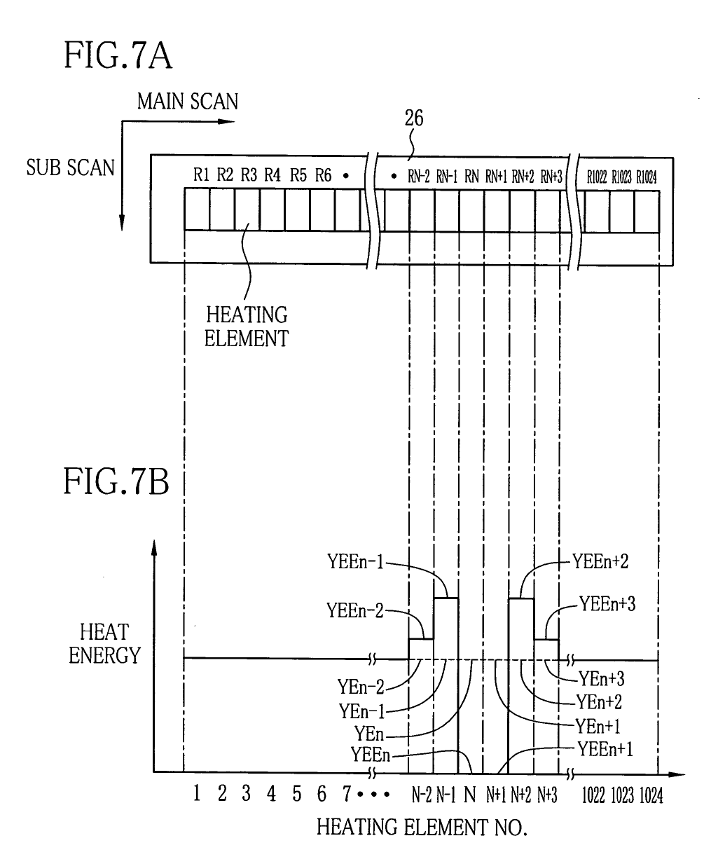

There will be a case where two successive heating elements RN and RN+1 have broken down, as shown for example in FIG. 7A. In this case, heat energies to be generated from those heating element RN−1 and RN+2 bordering on the broken heating elements RN and RN+1, and adjacent heating elements RN−2 and RN+3 to the bordering elements RN−1 and RN+2 are corrected in the same way as above, and the image data are corrected on the basis of the corrected heat energies.

However, because the white streak caused by the breakdown of successive two or more heating elements will have a wider width, it is hard to color out or fade out the white streak just by correcting the heat energy from the neighboring heating elements. Therefore, if the breakdown occurs in successive two or more of the heating elements, the error display 65 warns it, and requests the user to repair the thermal head 24. The error display 65 may be constituted of a plate with a warning “thermal head has a breakdown” and light emitting elements placed beside the plate to illuminate the plate when the breakdown is detected in more than one heating element. In order to display other malfunctions, an LCD may be used as the error display.

Now the operation of the above embodiment will be described.

When the color thermal printer 2 is powered, the system controller 34 controls the switch Sa shown in FIG. 5, to set the printer 2 in the resistance measuring mode. The resistance measuring circuit 64 and the resistance calculator 68 measure the resistance values of the heating elements R1 to R1024. At the same time, it is detected if any of the heating elements breaks down. The measured resistance values r1 to r1024 and, if there is one, the number N of the broken heating element RN, are written on the resistance memory 69.

After the resistance measurement, the color thermal printer 2 is set to the printing mode. When the memory card 49 storing image data is set in the memory slot 48, as shown in FIG. 4, the interface/memory controller 46 and the video output circuit 50 cause the monitor 51 to display video images based on the image data. The user chooses images to print with reference to the monitor 51, and enters a print start command. The image data of the chosen images are read out from the memory card 49, and written on the image memory 52. The system controller 34 reads out the image data from the image memory 52, and converts them to yellow, magenta and cyan image data.

The breakdown compensation operator 70 calculates heat energy values YEn, YEn−1, YEn+1, YEn−2 and YEn+2 necessary for printing yellow pixels by the broken heating element RN, the bordering heating elements RN−1 and RN+1, and the adjacent heating elements RN−2 and RN+2 respectively.

Thereafter, the corrected heat energy values YEEn, YEEn−1, YEEn+1, YEEn−2 and YEEn+2 are calculated from the heat energy values YEn, YEn−1, YEn+1, YEn−2 and YEn+2. Based on these corrected heat energy values, the yellow image data is corrected with respect to those pixels which are to be printed by the broken and neighboring heating elements RN, RN−1, RN+1, RN−2 and RN+2. The magenta image data and the cyan image data are corrected in the same way as the yellow image data. The corrected three color image data are written on the frame memory 55 in a color separated fashion.

The image correction circuit 56 further corrects the yellow, magenta and cyan image data, as written on the frame memory 55, on the basis of the resistance values of the heating elements R1 to R1024, the temperature 24 of the thermal head 24, the atmospheric temperature inside the housing of the thermal printer 2 and other factors. First, the yellow image data are read out line by line from the frame memory 55 to the line memory 59. The comparator 73 compares the yellow image data of one line, which are read out from the line memory 59, with gradation data from the system controller 34, to output serial drive data to the shift register 74.

The serial drive data are converted through the shift register 74 to parallel signals, which are latched at the latch array 77. The AND-gate of the AND-gate array 78 outputs a high level signal “H” in response to a strobe signal when the latched drive signal is “1”. Among the transistors Tr1 to Tr1025, those receiving the high level signal are turned on, to conduct current through the corresponding ones of the heating elements R1 to R1024, causing them to release heat energies.

After the image data are selected in the printing mode, and the print start command is entered, the feed motor 13 rotates forward to turn the paper feed roller 14 counterclockwise in the drawings, so the color recording paper 3 is fed out from the paper roll 4. The leading end of the color heat sensitive recording paper 3 is fed through the paper passageway to the feed roller pair 18, and is nipped between the conveyer rollers 18. Then, the color heat sensitive recording paper 3 is fed further in the forward direction. When the leading edge of the color heat sensitive recording paper 3 is detected by the optical sensor 33, the system controller 25 starts counting the number of pulses applied to the feed motor 13. The count value is used for determining the position of the color heat sensitive recording paper 3 in the paper passageway by the system controller 34.

When a print-starting position of the color heat sensitive recording paper 3 is set to a printing position of the thermal head 24, the feed motor 13 stops rotating. Then, the platen roller 28 is moved up by the shift mechanism, to nip the color heat sensitive recording paper 3 between the printing ridge 26 and the platen roller 28. The heating elements R1 to R1024 are heated in accordance with drive data that are supplied to a head driver 31, to print a yellow image on the yellow coloring layer 9 of the color heat sensitive recording paper 3.

During the yellow image printing, the corrected heat energy values YEEn, YEEn−1, YEEn+1, YEEn−2 and YEEn+2 are used for printing yellow pixels by the broken heating element RN, the bordering heating elements RN−1 and RN+1, and the adjacent heating elements RN−2 and RN+2 respectively, as shown in FIG. 3B. Thereby, the printed image does not have the white streak X, as shown in FIG. 3D.

When the yellow image printing is finished, the color heat sensitive recording paper 3 is conveyed forward till a trailing end of the printed image comes to a position facing the yellow fixing lamp 38 of the optical fixing device 37. Then the feed motor 13 stops rotating. Then, the platen roller 28 is moved down by the shift mechanism, to be apart from the thermal head 24. Next, the yellow fixing lamp 38 is turned on while the feed motor 13 is rotating reversely to feed the color heat sensitive recording paper 3 in the backward direction. Thereby, the yellow coloring layer 9 is fixed on the color heat sensitive recording paper 3.

The magenta and cyan images are printed sequentially on the color heat sensitive recording paper 3 in the same way as the yellow image. Because the magenta image data and the cyan image data are corrected in accordance with the correction results of the heat energy values to be generated from the broken and neighboring heating elements RN, RN−1, RN+1, RN−2 and RN+2, in the same way as for the yellow image data, the printed magenta and cyan images do not have the white streaks X. The correction coefficients a for the magenta image data, and those for the cyan image data are set higher than those for the yellow image data in accordance with the difference in heat sensitivity between these coloring layers. Therefore the white streaks are corrected or colored out at appropriate gradation levels.

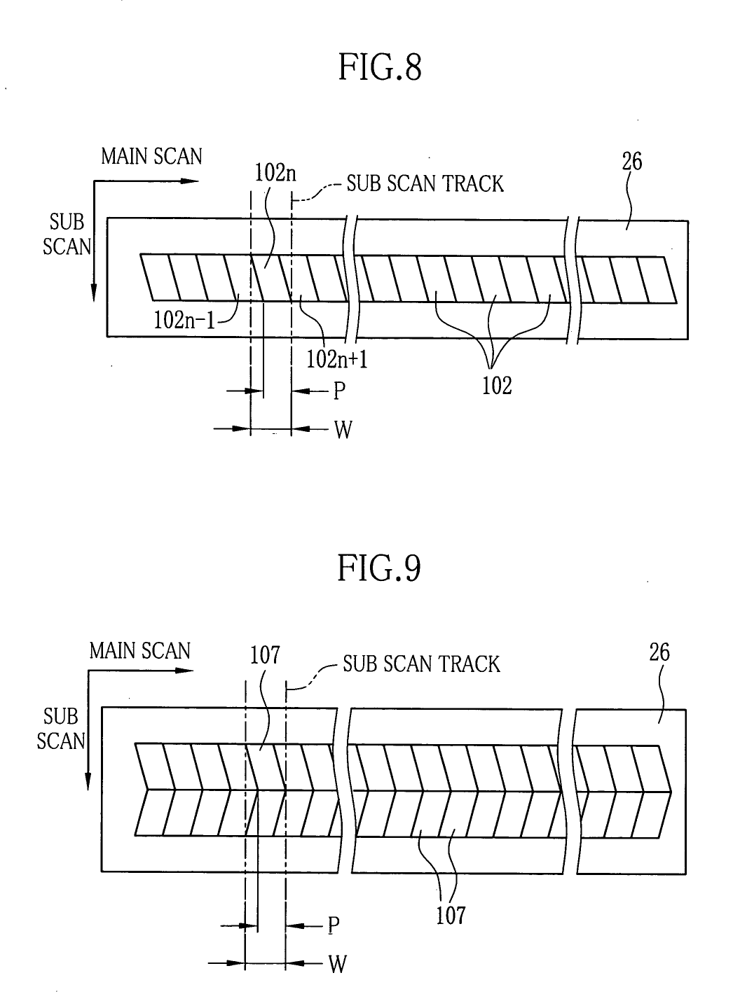

In the above embodiment, the individual heating elements R1 to R1024 are rectangular and extend orthogonal to the printing ridge 26 that extends in the main scan direction. That is, the individual heating elements R1 to R1024 extend in parallel to the sub scan direction. However, in another embodiment shown in FIG. 8, individual heating elements 102 extend aslant to the sub scan direction. According to this embodiment, bordering heating elements 102n−1 and 102n+1 partly trace a sub scan track of a broken heating element 102n, as show by phantom lines in FIG. 8. Therefore, it is possible to prevent the white streaks more reliably. In order to achieve the same effect, it is also possible to use such heating elements 107 as shown in FIG. 9, that are bent to extend aslant to the sub scan direction in opposite ways.

The inclination of the individual heating element is preferably defined to satisfy the following equation:
1<W/P=2
wherein P represents a width or length of one side of each heating element in the main scan direction, and W represents a whole length in the main scan direction of each heating element, i.e. a width of the sub scan track of each heating element.

Where W/P is not more than 1, the compensation effect of the bordering heating elements for the broken heating element is reduced. On the other hand, where W/P is more than 2, interference between adjacent heating elements becomes so large that the resolution of the printed image is lowered. Although the above described correction is effected on image data for those heating elements which border on the broken heating element or elements, and those adjacent to the bordering heating elements, it is possible to correct image data for much number of neighboring heating elements which are placed on opposite sides of the broken heating element, in addition to the bordering and adjacent heating elements. The correction coefficient a may be variable depending upon the gradation levels or heat energy values assigned to the neighboring heating elements, the head temperature and the atmospheric temperature, and other factors.

According to the above embodiment, the broken heating element is determined by measuring the resistance values of the respective heating elements. But it is possible to determine the broken heating element with reference to a test print. The test print has a uniform color, e.g. a neutral color, and a uniform density. The test print is read by an image reading device, like an image scanner. White streaks can be detected by analyzing subsequent image data, so the broken heating element is determined by the position of the detected white streak. In that case, it is preferable to print the heating element numbers on the test print, to facilitate determining the number of the broken heating element. Also a color thermal printer is provided with an input section for entering the number of the broken heating element. Then the image data may be corrected with reference to the entered number.

Although the above embodiment correct image data for the broken and neighboring heating elements, it is alternatively possible to correct drive data as being entered to the head driver. In order to correct the drive data, it is possible to correct the drive data after being output from the comparator 73, see FIG. 5, or it is possible to correct the gradation data before being input to the comparator 73.

Although the above embodiment has been described with respect to the direct color thermal printer, the present invention is applicable to thermal printers capable of printing monochrome images only, as well as thermal transfer type and sublimation type printers. Thus, the present invention is not to be limited to the above embodiments but, on the contrary, various modifications will be possible without departing from the scope and spirit of the present invention as specified in the claims appended hereto.

1. A white streak correction method for preventing white streaks from being caused by breakdown of any of a number of heating elements which are arranged in a line on a thermal head, and are heated in accordance with drive data generated from image data, to apply heat energies for printing a grayscale image line by line on a recording material, said method comprising steps of:
determining a broken heating element among said heating elements; and
correcting image data or drive data for neighboring ones of said heating elements, which are placed in the neighbor of said broken heating element, such that a percentage of heat energy to be applied from said broken heating element is added to heat energies applied from said neighboring heating elements.

2. A white streak correction method as claimed in claim 1, wherein said broken heating element determining step comprises a step of measuring respective resistance values of said heating elements.

3. A white streak correction method as claimed in claim 1, wherein said neighboring heating elements include at least heating elements bordering on said broken heating element and heating elements adjacent to said bordering heating elements on opposite sides from said broken heating element.

4. A white streak correction method as claimed in claim 3, wherein the image data or the drive data for said neighboring heating elements are corrected such that the percentage of added heat energy decreases with the distance from said broken heating element.

5. A white streak correction method as claimed in claim 3, wherein said thermal head is a thermal head for a color thermal printer that produces a color image by printing images of different colors on said recording material, and wherein correction amounts on the image data or the drive data for said neighboring heating elements are switched over among the different colors.

6. A white streak correction device for preventing white streaks from being caused by breakdown of any of a number of heating elements which are arranged in a line on a thermal head, and are heated in accordance with drive data generated from image data, to apply heat energies for printing a grayscale image line by line on a recording material, said apparatus comprising:
a determination device for determining a broken heating element among said heating elements;
a data correction device for correcting image data or drive data for neighboring ones of said heating elements, which are placed in the neighbor of said broken heating element, such that a percentage of heat energy to be applied from said broken heating element is added to heat energies applied from said neighboring heating elements.

7. A white streak correction device as claimed in claim 6, wherein said determination device comprises a device of measuring respective resistance values of said heating elements.

8. A white streak correction device as claimed in claim 6, wherein said neighboring heating elements include at least heating elements bordering on said broken heating element and heating elements adjacent to said bordering heating elements on opposite sides from said broken heating element.

9. A white streak correction device as claimed in claim 8, wherein said data correction device corrects the image data or the drive data for said neighboring heating elements by use of correction coefficients that vary depending upon the distance of each of said neighboring heating elements from said broken heating element.

10. A white streak correction device as claimed in claim 8, wherein said thermal head is a thermal head for a color thermal printer that produces a color image by printing images of different colors on said recording material, and wherein said data correction device corrects the image data or the drive data for said neighboring heating elements by use of correction coefficients determined by the color to print.

11. A white streak correction device as claimed in claim 8, wherein each of said heating elements is inclined to a perpendicular direction to a direction along which said heating elements are aligned.

12. A thermal printer comprising a thermal head having a number of heating elements arranged in a line along a main scan direction, wherein said heating elements are heated in accordance with drive data generated from image data, to apply heat energies from said heating elements for printing an image line by line on a recording material as said recording material is moved relative to said thermal head in a sub scan direction perpendicular to said main scan direction, said thermal printer comprising:
a determination device for determining a broken heating element among said heating elements; and
a data correction device for correcting image data or drive data for neighboring ones of said heating elements, which are placed in the neighbor of said broken heating element, such that a percentage of heat energy to be applied from said broken heating element is added to heat energies applied from said neighboring heating elements.

13. A thermal printer as claimed in claim 12, wherein said determination device comprises a device of measuring respective resistance values of said heating elements.

14. A thermal printer as claimed in claim 12, wherein said neighboring heating elements include at least heating elements bordering on said broken heating element and heating elements adjacent to said bordering heating elements on opposite sides from said broken heating element.

15. A thermal printer as claimed in claim 14, wherein the image data or the drive data for said neighboring heating elements are corrected such that the percentage of added heat energy decreases with the distance from said broken heating element.

16. A thermal printer as claimed in claim 14, wherein said thermal printer is a color thermal printer that produces a color image by printing images of different colors on said recording material, and wherein said data correction device corrects the image data or the drive data for said neighboring heating elements by use of correction coefficients determined by the color to print.

17. A thermal printer as claimed in claim 12, wherein each of said heating elements is inclined to said sub scan direction.

18. A thermal printer as claimed in claim 12, further comprising a warning device for warning about the breakdown when successive two or more of said heating elements break down.
